(19) United States
(12) Patent Application Publication
(10) Pub. No.: US 2026/0036229 A1
(43) Pub. Date: Feb. 5, 2026

(54) PIPE CABLE ASSEMBLY

(71) Applicant: Baker Hughes Energy Technology UK Limited, Bristol (GB)

(72) Inventor: Richard Alasdair CLEMENTS, Bristol (GB)

(21) Appl. No.: 18/997,709

(22) PCT Filed: Jul. 27, 2023
(86) PCT No.: PCT/EP2023/025351

§ 371 Date: Jan. 22, 2025

(30) Foreign Application Priority Data
Jul. 29, 2022 (GB) 2211121.5

(51) Int. Cl. F16L 11/127; F16L 11/22; H01B 7/04; H01B 7/14

(52) U.S. Cl. CPC F16L 11/127; F16L 11/22; H01B 7/04; H01B 7/14

(57) ABSTRACT

A method and apparatus for simultaneously transmitting power and transporting at least one fluid, and a method of manufacturing a pipe-power cable assembly, an offshore energy hub, and a method of installing a pipe member and an elongate flexible element at a desired location are disclosed. The apparatus comprises a pipe member comprising a fluid retaining liner that defines a bore of the pipe member; and at least one elongate flexible element comprising an outer sleeve and at least one electrically conducting element disposed within the outer sleeve; wherein the elongate flexible element is wound around the outer surface along at least a portion of the pipe member.

The present invention relates to a method and apparatus for transporting fluid and simultaneously transmitting power. In particular, but not exclusively, the present invention relates to a pipe-cable assembly including a fluid pipe and an electrical cable wound around the pipe member. Optionally the pipe-cable assembly is suitable for onshore or offshore use.

There is a demand for environmentally friendly and sustainable energy production. Renewable energy technology is therefore being implemented where possible to reduce pollution and other aberrant environmental side effects associated with energy production, and to provide usable energy to consumers without depleting the finite global resources such as fossil fuels. In particular, offshore wind farms are becoming more and more attractive due to the abundance of wind as an energy source, the ability to build energy production plants at remote locations and low associated cost to the environment in operation.

Offshore wind farms include one or more wind turbines located at an offshore location. The energy produced by such wind turbines is now sometimes utilised to also produce hydrogen from water via electrolysis. Hydrogen is a valuable source of energy and can be utilised in fuel cells or can be used to power vehicles and the like. However, most conventional methods of hydrogen production are environmentally damaging. Thus, it is desirable to produce so called “green” hydrogen from offshore wind farms significantly reducing the environmental cost associated with hydrogen production.

Following production, it is often necessary to transport hydrogen to and from various locations of an offshore wind farm, or to first convert the hydrogen to ammonia for transport and then transport it. Typically, pipes arranged on the seabed may be utilised to transport hydrogen and/or other fluids in and around an offshore wind farm. It is however known that hydrogen causes embrittlement of metallic materials. Thus, pipes including metals are prone to failure if used for hydrogen transport. Metallic pipes are thus not typically used to transport hydrogen. Pipes including composite materials are instead sometimes utilised.

Some fluid transport pipes which may comprise composite materials however tend to be substantially buoyant, particularly during hydrogen (or other) gas transport. The pipes thus require weighting down and/or affixing to the seabed in use. This can be a time consuming, complex and potentially dangerous operation in an offshore environment. Furthermore, affixing pipes to the seabed can be costly and reduces the reusability of such pipes.

Furthermore, it is often necessary to transmit power between various locations. These may be onshore and/or offshore locations. An example of an offshore location is an offshore wind farm. Power generated by wind turbines needs to be transmitted away from the wind turbine. Similarly, other components of an offshore wind farm, an electrolysis station for hydrogen production for example, require power to function and thus require a mechanism for power delivery. Often such power transmission is facilitated by subsea electrical cables. However, independently laying subsea electrical cables and fluid pipes can be time consuming and result in complex subsea configurations and architecture.

It is an aim of the present invention to at least partly mitigate one or more of the above-mentioned problems.

It is an aim of certain embodiments of the present invention to provide a pipe-cable assembly that can be installed as a single unit at a desired region.

It is an aim of certain embodiments of the present invention to provide a pipe-cable assembly for transport for fluid at an offshore region that is not buoyant in use.

It is an aim of certain embodiments of the present invention to provide a pipe cable assembly which comprises a low-cost composite reinforced fluid transmission pipe, free from metallic materials.

It is an aim of certain embodiments of the present invention to provide a pipe-cable assembly in which a subsea power cable is self-supported on a fluid pipe and does not require securement to the fluid pipe by connectors and the like.

It is an aim of certain embodiments of the present invention to provide apparatus for simultaneously transporting fluid and transmitting power to and/or from at least one element of an energy hub.

It is an aim of certain embodiments of the present invention to provide a method of simultaneously transporting fluid and transmitting power through a pipe-cable assembly.

It is an aim of certain embodiments of the present invention to provide a method of manufacturing a pipe-cable assembly for simultaneously transporting fluid and transmitting power.

According to a first aspect of the present invention there is provided apparatus for simultaneously transmitting power and transporting at least one fluid, comprising: a pipe member comprising a fluid retaining liner that defines a bore of the pipe member; and at least one elongate flexible element comprising an outer sleeve and at least one electrically conducting element disposed within the outer sleeve; wherein the elongate flexible element is wound around the outer surface along at least a portion of the pipe member.

Aptly, the fluid retaining liner is a fluid retaining polymer liner.

Aptly, the pipe member comprises a composite material.

Aptly, a first imaginary circle associated with a radially innermost surface of the outer sleeve of the wound elongate flexible element has a circle radius substantially equal to a circle radius of a further imaginary circle associated with the outer surface.

Aptly, a pitch between adjacent corresponding points of the wound elongate flexible element is in the range between two times a diameter of the outer surface in cross section and 50 times the diameter of the outer surface in cross section.

Aptly, a pitch between adjacent corresponding points of the wound elongate flexible element is in the range of two outside diameters of the pipe member to 50 outside diameters of the pipe member.

Aptly, the elongate flexible element wound around the outer surface is self-supported on at least a portion of the pipe member, the elongate flexible element optionally being helically wound around the outer surface.

Aptly, the elongate flexible element is helically wound around the outer surface.

Aptly, the elongate flexible element has a non-circular cross section that is optionally substantially elliptical.

Aptly the non-circular cross section is substantially elliptical.

Aptly, an aspect ratio of the non-circular cross section is not less than 1:2.

Aptly, the non-circular cross section is a stadium and comprises two substantially flat sides each joined by curved sides.

Aptly, the pipe member comprises a composite material, the composite material optionally comprising a thermoplastic matrix and fibres of a non-metallic material.

Aptly, a weight of the elongate flexible element is equal to or greater than a buoyancy of the pipe member when the pipe member is filled with gas.

Aptly, a weight of the elongate flexible element is equal to or greater than a buoyancy of the pipe member.

Aptly, a weight of the elongate flexible element is equal to or greater than a buoyancy of the pipe member when a transport fluid is disposed in the bore of the pipe member.

Aptly, in a storage configuration, the pipe member and the elongate flexible element wound around the outer surface are wound together around a spool and are unrollable as a common unit.

Aptly, the apparatus further comprises at least one armour layer disposed radially around the inner liner, the armour layer optionally comprising a composite material.

Aptly, the pipe member and the elongate flexible element wound around the outer surface are disposed between two structures that optionally are offshore structures.

Aptly, the pipe member incudes a permeation barrier layer.

According to a second aspect of the present invention there is provided an offshore energy hub, comprising: a pipe member comprising a fluid retaining liner that defines a bore of the pipe member; and at least one elongate flexible element comprising an outer sleeve and at least one electrically conducting element disposed within the outer sleeve; wherein the elongate flexible element is wound around the outer surface along at least a portion of the pipe member, disposed between at least two of: an energy generation element; an energy storage element; a fluid production element; a fluid storage element; and an offloading element.

Aptly, the pipe member comprises a composite material.

Aptly, a first imaginary circle associated with a radially innermost surface of the outer sleeve of the wound elongate flexible element has a circle radius substantially equal to a circle radius of a further imaginary circle associated with the outer surface.

Aptly, a pitch between adjacent corresponding points of the wound elongate flexible element is in the range between two times a diameter of the outer surface in cross section and 50 times the diameter of the outer surface in cross section.

Aptly, a pitch between adjacent corresponding points of the wound elongate flexible element is in the range of two outside diameters of the pipe member to 50 outside diameters of the pipe member.

Aptly, the elongate flexible element wound around the outer surface is self-supported on at least a portion of the pipe member, the elongate flexible element optionally being helically wound around the outer surface.

Aptly, the elongate flexible element is helically wound around the outer surface.

Aptly, the elongate flexible element has a non-circular cross section that is optionally substantially elliptical.

Aptly the non-circular cross section is substantially elliptical.

Aptly, an aspect ratio of the non-circular cross section is not less than 1:2.

Aptly, the non-circular cross section is a stadium and comprises two substantially flat sides each joined by curved sides.

Aptly, the pipe member comprises a composite material, the composite material optionally comprising a thermoplastic matrix and fibres of a non-metallic material.

Aptly, a weight of the elongate flexible element is equal to or greater than a buoyancy of the pipe member when the pipe member is filled with gas.

Aptly, a weight of the elongate flexible element is equal to or greater than a buoyancy of the pipe member.

Aptly, a weight of the elongate flexible element is equal to or greater than a buoyancy of the pipe member when a transport fluid is disposed in the bore of the pipe member.

Aptly, in a storage configuration, the pipe member and the elongate flexible element wound around the outer surface are wound together around a spool and are unrollable as a common unit.

Aptly, the energy generation element comprises a wind turbine or a subsea turbine.

Aptly, the fluid production element comprises at least one electrolysis system for generating hydrogen and/or at least one compression system to liquefy hydrogen.

Aptly, the fluid storage element comprises a geological reservoir.

Aptly, the energy storage element comprises batteries.

Aptly, the energy generation element is an energy generation structure.

Aptly, the energy storage element is an energy storage system.

Aptly, the fluid production element is a fluid production structure.

Aptly, the fluid storage element is a fluid storge or offloading structure.

Aptly the offloading element is an offloading structure.

Aptly, the apparatus further comprises at least one armour layer disposed radially around the inner liner, the armour layer optionally comprising a composite material.

Aptly, the pipe member and the elongate flexible element wound around the outer surface are disposed between two structures that optionally are offshore structures.

Aptly, the pipe member incudes a permeation barrier layer.

According to a third aspect of the present invention there is provided a method of installing a pipe member and an elongate flexible element at a desired location, comprising: unwinding a pipe member comprising a fluid retaining liner that defines a bore of the pipe member; and at least one elongate flexible element comprising an outer sleeve and at least one electrically conducting element disposed within the outer sleeve; wherein the elongate flexible element is wound around the outer surface along at least a portion of the pipe member, and wherein in a storage configuration, the pipe member and the elongate flexible element wound around the outer surface are wound together around a spool and are unrollable as a common unit, from the spool at a desired location that optionally is an offshore location.

Aptly, the elongate flexible element is a power cable.

Aptly, the desired location is a desired region.

Aptly, the offshore location is an offshore region.

Aptly, the desired location is an offshore location.

Aptly, the offshore location is a location intended as an energy hub.

Aptly, the offshore location is a region intended as an energy hub.

Aptly, the pipe member comprises a composite material.

Aptly, a first imaginary circle associated with a radially innermost surface of the outer sleeve of the wound elongate flexible element has a circle radius substantially equal to a circle radius of a further imaginary circle associated with the outer surface.

Aptly, a pitch between adjacent corresponding points of the wound elongate flexible element is in the range between two times a diameter of the outer surface in cross section and 50 times the diameter of the outer surface in cross section.

Aptly, a pitch between adjacent corresponding points of the wound elongate flexible element is in the range of two outside diameters of the pipe member to 50 outside diameters of the pipe member.

Aptly, the elongate flexible element wound around the outer surface is self-supported on at least a portion of the pipe member, the elongate flexible element optionally being helically wound around the outer surface.

Aptly, the elongate flexible element is helically wound around the outer surface.

Aptly, the elongate flexible element has a non-circular cross section that is optionally substantially elliptical.

Aptly the non-circular cross section is substantially elliptical.

Aptly, an aspect ratio of the non-circular cross section is not less than 1:2.

Aptly, the non-circular cross section is a stadium and comprises two substantially flat sides each joined by curved sides.

Aptly, the pipe member comprises a composite material, the composite material optionally comprising a thermoplastic matrix and fibres of a non-metallic material.

Aptly, a weight of the elongate flexible element is equal to or greater than a buoyancy of the pipe member when the pipe member is filled with gas.

Aptly, a weight of the elongate flexible element is equal to or greater than a buoyancy of the pipe member.

Aptly, a weight of the elongate flexible element is equal to or greater than a buoyancy of the pipe member when a transport fluid is disposed in the bore of the pipe member.

Aptly, the apparatus further comprises at least one armour layer disposed radially around the inner liner, the armour layer optionally comprising a composite material.

Aptly, the pipe member and the elongate flexible element wound around the outer surface are disposed between two structures that optionally are offshore structures.

Aptly, the method further comprises laying the pipe member and elongate flexible element wound around the outer surface between two offshores structures along a region of seabed.

Aptly, the pipe member incudes a permeation barrier layer.

According to a fourth aspect of the present invention, there is provided a method of simultaneously transmitting power and transporting at least one fluid, comprising: providing at least one fluid at first location of a bore defined by a fluid retaining inner liner of a pipe member; providing power via least one electrically conducting element disposed within an outer sleeve of an elongate flexible element, the elongate flexible element being wound around an outer surface of the pipe member along at least a portion of the pipe member; and transporting the fluid in a first direction along the bore of the pipe member from the first location to a second location that is spaced apart from the first location along the bore of the pipe member; and providing power through the electrically conducting element at least partly during, or at all times during, transport of the fluid.

Aptly, the pipe member comprises a composite material.

Aptly, the method further comprises providing power in a transmission direction that is opposite to or aligned with a direction in which fluid is transported.

Aptly, the fluid comprises hydrogen.

Aptly, the fluid comprises ammonia, or CO₂, or a fluid solution in which CO₂ is dissolved or trapped.

Aptly, the method further comprises via the bore, transporting the fluid from a first structure to a further structure and simultaneously transmitting, via the electrically conducting element, power from the first structure to a further structure or from the further structure to the first structure, the first and further structure each optionally being a respective offshore structure.

According to a fifth aspect of the present invention there is provided a method of manufacturing a pipe-power cable assembly, comprising: providing a pipe member comprising a fluid retaining inner liner that defines a bore of the pipe member; providing an elongate flexible element comprising an outer sleeve and at least one electrical conductor element arranged within the outer sleeve; and winding the elongate flexible element around the outer surface along at least a portion of the pipe member.

Aptly, the pipe member comprises a composite material.

Aptly, the method further comprises subsequent to winding the elongate flexible element around the outer surface, simultaneously winding the pipe member, and the elongate flexible element wound around the outer surface of the pipe member, together around a storage spool element.

Certain embodiments of the present invention provide a pipe-cable assembly installable as a common unit at a desired location.

Certain embodiments of the present invention provide apparatus that facilitates simultaneous transport of fluid and transmission of power.

Certain embodiments of the present invention provide a method of simultaneous transport of fluid and transmission of power through a pipe-cable assembly. Optionally power and fluid can be transmitted in the same or alternatively opposite directions.

Certain embodiments of the present invention provide a reduced need to compensate for the buoyancy of a fluid pipe installed at an offshore region.

Certain embodiments of the present invention provide a method of simultaneously transporting fluid and transmitting power to and/or from at least one element of an energy hub.

Certain embodiments of the present invention provide a method of self-supporting an elongate flexible element on a pie member without a need for connecting elements and the like.

Certain embodiments of the present invention provide a transportable hybrid pipe system including a subsea power cable and a fluid pipe together wrapped around a spool.

Embodiments of the present invention will now be described hereinafter, by way of example only, with reference to the accompanying drawings in which:

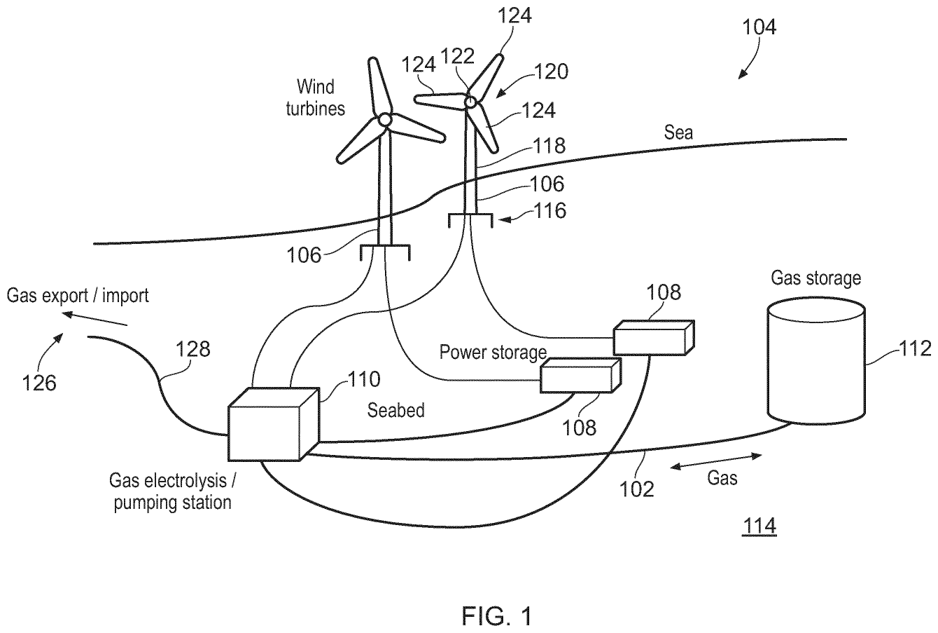

FIG. 1 illustrates a hybrid pipe system located at an offshore energy hub;

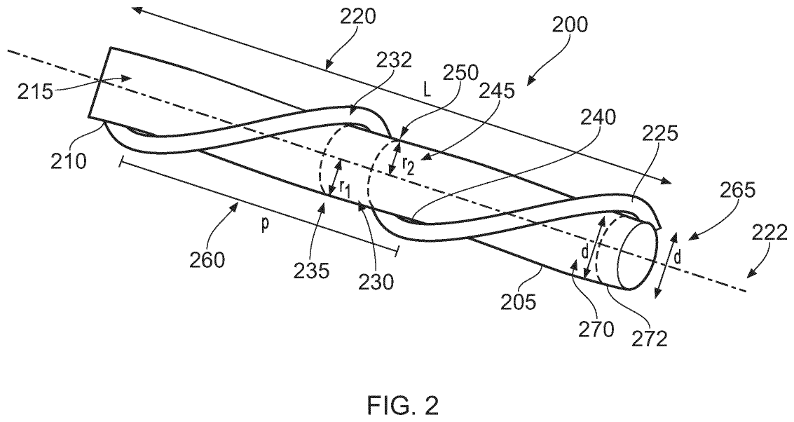

FIG. 2 illustrates a perspective view of a hybrid pipe-cable system;

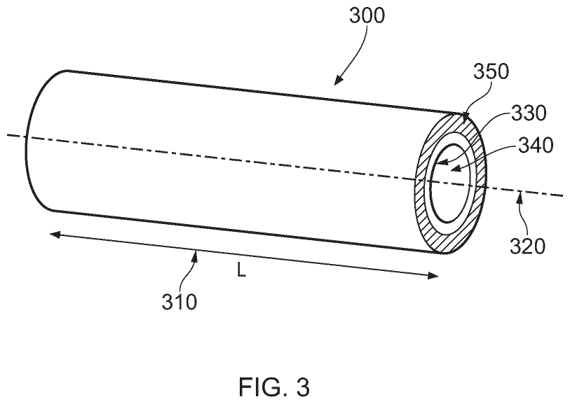

FIG. 3 illustrates a fluid pipe in more detail;

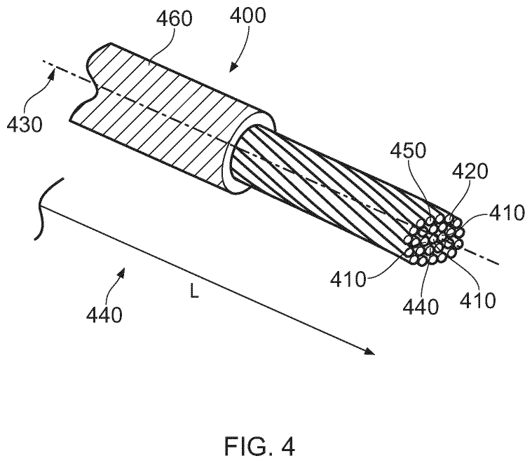

FIG. 4 illustrates a subsea electrical cable in more detail;

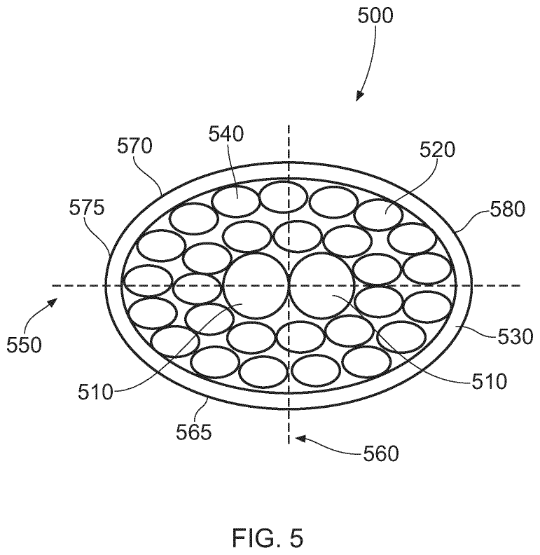

FIG. 5 illustrates an alternative subsea electrical cable in cross section;

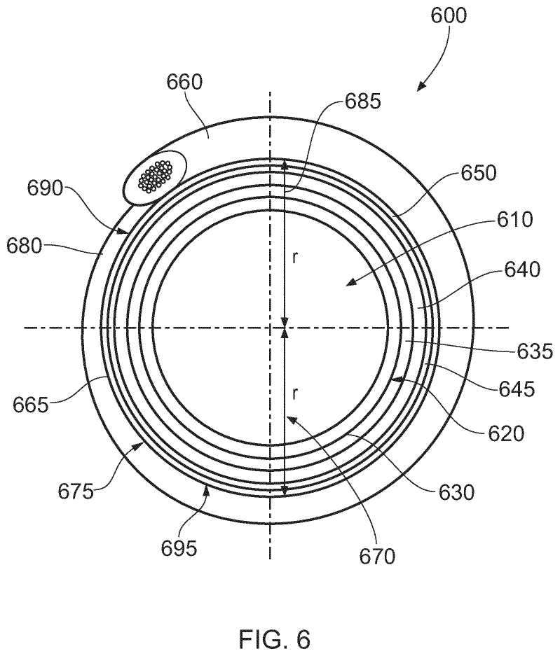

FIG. 6 illustrates a pipe-cable assembly in cross section;

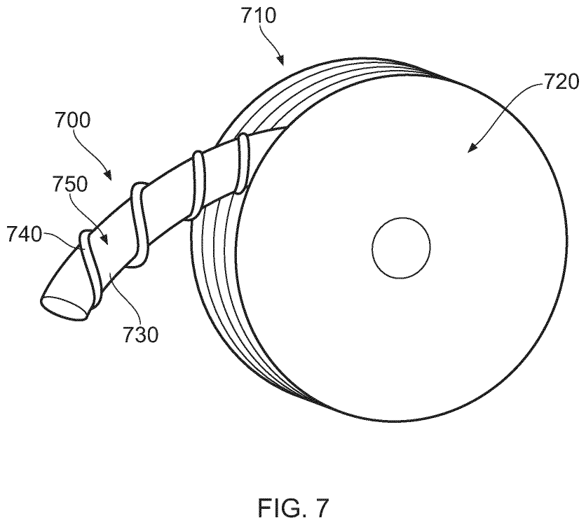

FIG. 7 illustrated a hybrid pipe-cable system arranged in a storage configuration; and

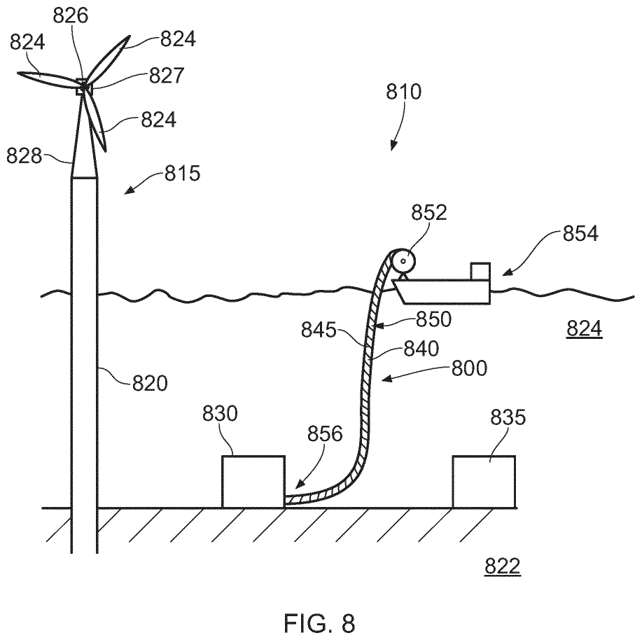

FIG. 8 illustrates installation of a hybrid pipe system at an offshore region.

In the drawings like reference numerals refer to like parts.

FIG. 1 illustrates a first hybrid pipe system 102 arranged between two structures at an offshore region 104. It will be appreciated that the hybrid pipe system 102 is an example of a pipe-cable assembly. It will be appreciated that the offshore region 104 is an example of an offshore environment. The offshore region 104 of FIG. 1 is an offshore wind farm and includes a number of offshore structures 106, 108, 110, 112 arranged on the seabed 114. These structures 106, 108, 110, 112 are partly or wholly submerged by seawater. It will be appreciated that the offshore wind farm, that is an example of an offshore region 104, is an example of an energy hub. It will also be appreciated that the structures 106, 108, 110, 112 are examples of energy hub elements. It will also be appreciated that the hybrid pipe system 102 may instead be connected between structures that are not part of an energy hub.

It will be understood that the hybrid pipe system 102 may instead be utilised in an onshore environment or to connect onshore locations to offshore locations. It will be appreciated that the hybrid pipe system 102 may instead be utilised in an onshore energy hub. It will also be appreciated that the hybrid pipe system 102 may instead be connected between structures that are not part of an energy hub.

The offshore energy hub of FIG. 1 includes two offshore wind turbines 106. It will be understood that a single wind turbine 106 could instead be utilised. Alternatively, it will be appreciated that more than two wind turbines 106 could be utilised. The wind turbines 106 are examples of energy generation elements. Alternatively, different energy generation elements could be utilised. For example, subsea turbines, tidal or wave power generation systems could instead be utilised.

The offshore wind turbines 106 each include a monopile 116 and a tower 118 mounted on top of the monopile 116. The monopile 116 is at least partly submerged in seawater and extends into the seabed 114. Each monopile 116 thus anchors a respective offshore wind turbine 106 to the seabed 114 and acts as a base for tower 118. A turbine 120 is attached to the top of the tower 118. A rotor 122 of the turbine 120 is attached to three turbine blades 124. Aptly any other suitable number of turbine blades 124 could be utilised. In use, wind provides a force on the turbine blades 124 which rotates the rotor 122. The rotor is connected to a generator which is spun by the rotating rotor 122 and generates electricity. It will be appreciated that the force could be measured in Newtons and could be derived by measuring wind speed which could be measured using anemometers. It will also be appreciated that the wind turbines may be of the floating type, rather than fixed directly to the seabed.

The offshore wind farm of FIG. 1 also includes two power storage structures 108. It will be appreciated that the power storage structures 108 are examples of energy storage elements. The power storage 108 structures of FIG. 1 include batteries to store energy generated by the offshore wind turbines 106 as chemical potential energy. Aptly, other energy storage devices could be utilised for example capacitors, flywheels and the like.

The offshore wind farm illustrated in FIG. 1 also includes an electrolysis structure 110. It will be understood that optionally no electrolysis structure would be included. The electrolysis structure 110 is an example of a fluid production element. An alternative fluid production element may comprise an ammonia production system, for example. The electrolysis structure 110 produces hydrogen gas from water by electrolysis. The electrolysis structure 110 thus breaks down water into oxygen and hydrogen by utilising an electric direct current by introducing an anode and a cathode into a volume of water, the hydrogen from which is then pumped into a gas storage structure 112, or is converted into ammonia for subsequent storage in a gas storage structure, for example.

The offshore wind farm of FIG. 1 also includes a gas storage structure 112. It will be appreciated that the gas storage structure 112 is an example of a fluid storage element. The gas storage structure 112 of FIG. 1 is a reservoir into which produced hydrogen can be transported for storage. Similarly, the gas storage structure 112 of FIG. 1 is a reservoir of stored hydrogen or ammonia from which hydrogen or ammonia can be supplied to other structures 106, 108, 110 of the offshore wind farm or transported out of the offshore wind farm to other energy systems that may, for example, be onshore energy systems, or an offshore fuel delivery system for shipping, for example. Aptly the gas storge structure 112 is a natural reservoir, for example a cavity in the seabed.

The offshore wind farm of FIG. 1 also includes a gas import/export element 126. It will be appreciated that the gas import/export element 126 is a device that facilitates the introduction or removal of hydrogen or ammonia, or CO₂ to/from the offshore wind farm of FIG. 1. Aptly other suitable fluids could be utilised.

Aptly a variety of other suitable structures may instead be utilised in the offshore wind farm of FIG. 1. It will be appreciated that any of the structures 106, 108, 110, 112 of the offshore wind farm of FIG. 1 may include a pumping system to facilitate the transport of gas between structures 106, 108, 110, 112 of the offshore wind farm (or out of the offshore wind farm). For example, the electrolysis structure 110 may include a pumping system. Alternatively, the offshore wind farm may include a pumping structure that may be a pumping station. Aptly any of the structures 106, 108, 110, 112 of the offshore wind farm of FIG. 1 may include a compression system to liquify produced hydrogen, or a system to produce liquid ammonia, or a system to combine CO₂ with a solvent medium in preparation for storing or sequestering that CO₂ in a storage reservoir. For example, the electrolysis structure 110 of FIG. 1 may include a compression system. Alternatively, the offshore wind farm may include a compression system that may be a compression station. Alternatively, the offshore wind farm may include or be connected to a fueling station for shipping to provide ships with hydrogen or ammonia to power their electrical systems and/or their propulsion systems, for example. Alternatively or additionally, the offshore wind farm may include or be connected to an off-loading station for shipping to enable the discharge of CO₂, or of a fluid solution in which CO₂ is dissolved or trapped, for example.

The first hybrid pipe system 102 of FIG. 1 is arranged on the seabed 114 of the offshore region 104 in which the offshore wind farm is located. The first hybrid pipe system 102 is thus submerged in seawater. It will be appreciated that the first hybrid pipe system 102 is an example of a pipe cable assembly that is a pipe power cable assembly. As illustrated in FIG. 1, the first hybrid pipe system 102 is connected between the electrolysis structure 110 and the gas storage structure 112. The first hybrid pipe system thus facilitates the transport of produced hydrogen into storage and the transport of stored hydrogen to other structures of the offshore wind farm. It will be appreciated that the first hybrid pipe system 102 may instead be connected between any suitable structures of the offshore wind farm of FIG. 1. FIG. 1 also illustrates a second hybrid pipe system 128 connected between the electrolysis structure 110 and the gas export/import element. The second hybrid pipe system 126 thus facilitates the transport of hydrogen into, and out of, the offshore wind farm.

FIG. 2 illustrates a perspective view of a hybrid pipe system 200. The hybrid pipe system of FIG. 2 may be substantially the same as the first and further hybrid pipe systems 102, 128 of FIG. 1. The hybrid pipe system 200 includes a fluid pipe 205 and a subsea electrical cable 210. It will be appreciated that the fluid pipe 205 is an example of a pipe member. It will be appreciated that the subsea electrical cable 210 is an example of an elongate flexible element. It will be appreciated that the subsea electrical cable 210 may instead be a different type of electrical cable, for example a cable suitable for use in an onshore environment. It will be appreciated that the subsea electrical cable 210 may be an umbilical comprising a plurality of electrical and/or control cable systems. Aptly the cable 210 may be an umbilical comprising any other suitable elements and/or systems.

As illustrated in FIG. 2, the subsea electrical cable 210 is wound around an outer surface 215 of the fluid pipe 205. The wound subsea electrical cable 210 extends along a length 220 of the fluid pipe 205. Aptly the subsea electrical cable 210 may only extend along a portion of the length 220 of the fluid pipe 202. It will be understood that the length 220 of the fluid pipe refers to the extension of the fluid pipe 205 along the major axis 222 of the fluid pipe 205. The subsea electrical cable 210, wound around the outer surface 215 of the fluid pipe 205, is self-supported on the fluid pipe 205. That is to say that the subsea electrical cable 210 is wound substantially tightly onto the fluid pipe 205 such that the subsea electrical cable 210 is effectively affixed to the fluid pipe 215 without a need for any further attachment elements. One or two (or more) additional attachment or securing elements could of course be included as desired. It will be appreciated that the length 220 could be measured in meters and could be measured using a tape.

The subsea electrical cable 210 includes an outer sleeve 230 which covers the subsea electrical cable and provides an outer surface 232 of the subsea electrical cable 210. Aptly the outer sleeve includes a polymeric material. Aptly the outer sleeve is impermeable to water. Aptly the electrical cable comprises armouring elements, such as armouring wires. Aptly the electrical cable comprises electrically conductive elements, such as copper or aluminium wires. The subsea electrical cable 210 is wound around the outer surface 215 tightly such that the radius 230 of a first imaginary circle 235 defined by a radially innermost surface 240 of the wound subsea electrical cable 210 (that is to say the first imaginary circle 235 is a 2-dimensional representation of the windings of the wound subsea electrical cable 210 with a size equal to the radially innermost surface 240 of the windings) is substantially the same as the radius 245 of a further imaginary circle 250 defined by the outer surface 215 of the fluid pipe 205. That is to say that the wound subsea electrical cable tightly hugs the outer surface of the fluid pipe.

It will be appreciated that the first and further imaginary circles 235, 250 are circles that do not physically exist but serve to represent the innermost radial dimension of the wound subsea power cable 210 and the outermost radial dimension of the outer surface 215 of the fluid pipe 205 respectively.

It will be appreciated that the radii 230, 245 could be measured in metres and could be measured using a tape measure.

It will be appreciated that a radially innermost surface 240 of the wound subsea electrical cable 210 is the surface, that is to say a physical limit of the outer part of the cable 210, that is disposed inside of the windings when the subsea electrical cable 210 is wound around the outer surface 215 of the fluid pipe 205 and is thus the portion of the subsea electrical cable in closest proximity to the fluid pipe 205.

As illustrated in FIG. 2, the subsea electrical cable 210 is wound around the outer surface 215 of the fluid pipe 205 such that the windings of the subsea electrical cable 210 have a defined pitch 260. It will be understood that the pitch of the wound subsea electrical cable 210 is the distance between two corresponding points on adjacent windings of the wound subsea electrical cable 210. Aptly, the pitch of the wound subsea electrical cable 210 is in a range between two and fifty times an outer diameter 265 of the fluid pipe 205, that is a diameter 265 of the outer surface 215 of the fluid pipe 205. It will be appreciated that the outer diameter 265 of the fluid pipe is the diameter of a still further imaginary circle 272 of a size equal to the outer surface 215 of the fluid pipe 205. The pitch may be constant along the pipe-cable assembly or might be greater or lesser in desired regions.

As indicated the hybrid pipe system 200 of FIG. 2, the subsea electrical cable 210 is wound around the outer surface 215 of the fluid pipe 205 in a substantially helical arrangement. That is to say that the windings of the subsea electrical cable 210, around the fluid pipe 205, define a substantially helical in shape. Aptly the subsea electrical cable 210 may be wound unevenly such that the windings do not have a helical shape. Aptly the subsea electrical cable 210 may be wound loosely around the outer surface of the fluid pipe 205.

It will be appreciated that the fluid pipe 205 is configured to transport a fluid in use. That is to say that the fluid pipe 205 is a conduit through which a fluid can pass. It will be understood that transporting a fluid involves moving a fluid from a first location to a further location. The hybrid pipe system 200 of FIG. 2 thus facilitates the passage of fluid from a first end of the hybrid pipe system 200 to a further end of the hybrid pipe system 200. It will be appreciated that, in use and when connected between at least two elements of an energy hub such as an offshore wind farm, the hybrid pipe facilitates transport of a fluid between the two energy hub elements.

The fluid configured to be transported via the fluid pipe 205 is optionally a gas. The gas is optionally hydrogen. Alternatively, it will be appreciated that the fluid pipe 205 may be configured to transport a different gas, for example carbon dioxide, oxygen, helium, methane, and the like. Alternatively, the fluid pipe may be configured to transport a liquid. Aptly the liquid is liquid hydrogen. Optionally the fluid pipe 205 may be configured to transport a different liquid, for example liquid ammonia. Optionally the liquid is a fluid solution in which CO₂ is dissolved or trapped. Liquid hydrogen may be produced by compressing hydrogen generated by electrolysis at an offshore wind farm. Optionally the fluid pipe may be configured to transport any other suitable fluid which may, for example, be a liquid. Combinations of gasses or liquids or gasses and liquids could also be transported.

It will be appreciated that, in use, the fluid pipe 205 will have an associated buoyancy. For example, when disposed in an offshore environment where the fluid pipe 205 could be subsea, the fluid pipe 205 may be buoyant. In particular when a fluid such as a gas is present in the fluid pipe 205, the fluid pipe may be buoyant. The subsea electrical cable 210 includes one or more heavy elements, for example wires and the like. The subsea electrical cable 210 may include one or more wire that is an electrical power line that is an electrical power conductor. The subsea electrical cable 210 may also include one or more wire that is a reinforcing wire. Such wires are optionally metallic elements. That is to say the wires may include a metal material such as copper, or steel, or aluminium, for example. The subsea electrical cable 210 has an associated weight. The weight of the subsea electrical cable 210 is greater than the buoyancy of the fluid pipe 205 when a fluid is present in the fluid pipe 205. Thus, the subsea electrical cable 210 acts as a counterweight and counteracts the buoyancy of the fluid pipe 205 when a fluid is located in the fluid pipe 205. The weight of the subsea electrical cable 210 therefore prevents the fluid pipe 205 from floating in use and allows the hybrid pipe system 200 to remain stable on the seabed in use. Thus, no further counterweight are necessary to counteract the buoyancy of the fluid pipe 205 when in use in an offshore environment.

It will be appreciated that the buoyancy of the fluid pipe 205 of a given volume can be measured in Newtons and can be derived by measurement of the density of an environmental fluid (seawater for example) which can be measured using a hydrometer.

It will be appreciated that the weight of the subsea electrical cable 210 can be measured in Newtons and can be measured by weighing.

It will be appreciated that the fluid pipe 205 of the hybrid pipe system 200, in use in an offshore wind farm, is connected to at least one element of an offshore wind farm. These elements may be any of the structures 106, 108, 110, 112 illustrated in FIG. 1. Aptly, an offshore wind farm may include any other suitable elements that may be offshore structures. The fluid pipe 205 may be connected between two, or more, elements of the offshore wind farm. As previously indicated, the hybrid pipe system 200, via the fluid pipe 205, facilitates the transport of a fluid from and/or to an element of the offshore wind farm. For example, the hybrid pipe system may facilitate transport of fluid from a fluid production element, which may be an electrolysis structure 110, to and fluid storage element, which may be a gas reservoir 112. It will be appreciated that fluid production element may include one electrolysis system or a plurality of electrolysis systems for hydrogen production. The fluid storage element may, for example, be a natural reservoir or a manufactured storage unit. Aptly the reservoir may be a geological reservoir, for example a cavity under the seabed 114. It will be appreciated that the fluid production element and/or the fluid storage element may include one or more compression system for liquification of hydrogen, for example.

It will be understood that the subsea electrical cable 210, in use in an offshore wind farm, is connected to at least one element of an offshore wind farm. The subsea electrical cable 210 may be connected between two, or more, elements of the offshore wind farm. The subsea electrical cable 210 may be connected to the same element or elements of the offshore wind farm as the fluid pipe 205. Alternatively, the subsea electrical cable 210 may be connected to a different element, or between different elements, of the offshore wind farm than the fluid pipe 205. It will be appreciated that the subsea electrical cable 210 facilitates transmission of power to and/or from an element of the offshore wind farm. For example, the subsea electrical cable 210 may facilitate transmission of power from an energy generation element, for example at least one wind turbine, to an energy storage element, for example at least one battery. Aptly the subsea electrical cable 210 may supply the requisite power for various elements of an offshore wind farm to operate. For example, the subsea electrical cable 210 may supply a fluid production element with the energy required to provide electrolysis to generate hydrogen from water. Similarly, the subsea electrical cable may supply pumps with the requisite power to transport a fluid from a first location of the offshore wind farm to a further location of the offshore wind farm via the fluid pipe 205.

It will be appreciated that power transmission relates to the provision of a current through an electrical conductor due to a potential different between a voltage at a first circuit position and a voltage at a second circuit position. Transmission of power from a source to a power receiving element occurs via one or more power conductors of the subsea electrical cable 210. It will be appreciated that a power conductor of the subsea power cable is an example of an electrically conducting element.

The hybrid pipe system 200 allows for the transmission of electrical power via the subsea electrical cable 210 and the transport of a fluid via the fluid pipe simultaneously. That is to say, fluid can be transported at the same time as power is transmitted via the hybrid pipe system 200. Thus, the hybrid pipe system 200 facilitates transmission of a fluid, via the fluid pipe 205, and transmission of power, via the subsea electrical cable 210, simultaneously. It will be appreciated that power transmission via the subsea electrical cable 210 may occur only partly as fluid is transported via the fluid pipe 205. Alternatively, power transmission via the subsea electrical cable 210 may occur continuously as fluid is transmitted via the fluid pipe 205. That is to say that power may be transmitted throughout the whole period of time in which fluid transport takes place or alternatively power may be transmitted intermittently and thus only partly throughout the period of time in which fluid transport takes place.

It will be appreciated that power may be transmitted in a transmission direction that is the same as, or opposite to a direction in which fluid is transported via the hybrid pipe system 200. That is to say that the net/average direction of power transmission through the subsea electrical cable 210 may be the same as, or opposite to that of the direction of fluid transport through the fluid pipe 205. It will be appreciated that the direction of fluid transport through the fluid pipe 205 will be in a direction that is parallel to the pipe axis 222. It will be understood that power is transmitted via the subsea electrical cable 210 through the windings of the subsea electrical cable 210 that is wound around the fluid pipe 205. Thus, the instantaneous transmission of power via the subsea electrical cable 210, through the windings, will be at an angle that is oblique to the axis 222 of the hybrid pipe system 200. However, it will be appreciated that the net direction of power transmission, that is a power transmission direction, through the subsea electrical cable 210 will be along the pipe axis 222 and thus will be is the same direction as, or opposite to, the direction of fluid transport through the fluid pipe 205.

FIG. 3 illustrates a fluid pipe 300 in more detail. It will be appreciated that the fluid pipe 300 of FIG. 3 may be the same as the fluid pipe 200 illustrated in FIG. 2. As discussed previously with respect to FIGS. 1 and 2, a fluid pipe 300 is an example of a pipe member. The fluid pipe 300 illustrated in FIG. 3 is generally cylindrical in shape. That is to say that the fluid pipe 300 of FIG. 3 is generally tubular. The fluid pipe has a length 310 that extends along a primary axis 320 of the fluid pipe 300. As shown in FIG. 3, the fluid pipe 300 includes a fluid retaining liner 330 which defines a bore 340 of the fluid pipe 300. That is to say that the fluid retaining liner 330 surrounds an internal cavity that is a bore 340 of the fluid pipe 300. It will be appreciated that the bore 340 of the fluid pipe receives a fluid in use during fluid transport. Aptly the fluid includes a gas. Aptly the fluid includes hydrogen. Aptly the fluid includes ammonia. Aptly the fluid includes carbon dioxide. Aptly the fluid is a fluid solution in which CO₂ is dissolved or trapped. Aptly the fluid includes a liquid. It is the bore 340 of the fluid pipe through which the fluid moves during transport.

The fluid retaining liner 330 is generally cylindrical. That is to say that the fluid retaining liner 330 is generally tubular. The fluid retaining liner 330 is substantially impermeable to a fluid intended to be transported through the bore 340 of the fluid pipe 300. Thus, the fluid retaining liner 330 substantially prevents fluid leakage from the bore 340 of the fluid pipe 300 to a surrounding environment. Aptly the fluid retaining layer 330 includes a polymer material. Aptly the fluid retaining liner 330 includes a composite material. Aptly the fluid retaining liner 330 comprises a thermoplastic composite material. Examples of suitable polymer materials include polyolefins, polyamides, polyketones, fluroropolymers such as PVDF, PEEK, or PEKK, or TV resins. Aptly the fluid retaining liner 330 is reinforced with non-metallic fibres. Examples of suitable non-metallic fibres include glass, basalt, carbon, and tensilised polymers. Optionally a permeation barrier layer may be included outside the fluid retaining liner. The permeation barrier layer may comprise a film or foil of a low permeation material, such as aluminium or a metallised polymer tape.

The fluid pipe of FIG. 3 includes an outer layer 350. Aptly the outer layer 350 includes a polymer material. Aptly the outer layer 350 includes a composite material. Aptly the fluid outer layer comprises a thermoplastic composite material. Aptly the outer layer 350 is reinforced with non-metallic fibres. The outer layer 350 of FIG. 3 is a reinforcement layer that supports the tubular structure of the fluid pipe 300. Aptly the fluid pipe 300 includes only a single layer that is a fluid retaining liner 330 which optionally is reinforced with non-metallic fibres for structural stability. Optionally the fluid pipe 300 may contain more than two layers. For example, the fluid pipe 300 may include one or more armour layers disposed radially around the fluid retaining liner 330. The armour layers may be made from composite material. Aptly, the armour layers may be made from metallic material. The armour layers may include tensile armour layers and/or pressure armour layers. The armour layers may include a plurality of interlocking helically wound tapes. The armour layers may instead include at least one helically wound non-interlocking tape. The fluid pipe 300 may also include a carcass layer disposed within the bore of the fluid pipe. The carcass layer may include a helically wound tape with interlocking adjacent windings. A multilayer fluid pipe 300 may optionally include a water impermeable outer sheath. Aptly the fluid pipe includes more than two concentrically arranged layers of composite material. Aptly the subsea electrical cable 400 may include an electrically insulating material disposed between the power conductors 410 in order to help isolate each power conductor.

Depending on the fluid to be conveyed, the fluid pipe 300 may be manufactured from a variety of different suitable materials. The fluid pipe of FIG. 3 is a hydrogen transport fluid pipe 300 and this includes composite and/or non-metallic materials. The fluid pipe 300 of FIG. 3 thus does not suffer from embrittlement in use due to hydrogen exposure. A fluid pipe 300 configured for transport of other gasses, such as carbon dioxide, may instead include metal layers for structural support, for example.

FIG. 4 illustrates a subsea electrical cable 400 in more detail. The subsea electrical cable 400 of FIG. 4 includes three power conductors 410. It will be appreciated that the power conductors 410 are examples of electrically conducting elements. The power conductors 410 of FIG. 4 are made from copper. Alternatively, the power conductors could be made from any other suitable material that is electrically conductive. Aptly the power conductors include an electrically conductive metallic material. It will be appreciated that the power conductors 410 extend from a first terminal end of the subsea electrical cable 400 to the remaining terminal end of the subsea electrical cable 400 and act to transmit power from the first terminal end of the subsea electrical cable 400 to the other end of the subsea electrical cable 400 or vice versa. The subsea electrical cable 400 also includes a plurality of reinforcing wires 420. The reinforcing wires 420 protect the power conductors 410 from damage when the subsea power cable 400 is flexed or wound around another body such as a fluid pipe. The subsea electrical cable 400 of FIG. 4 includes 24 reinforcing wires 420. Aptly the subsea power cable 400 may include any other suitable number of reinforcing wires 420. As illustrated in FIG. 4, the reinforcing wires 420 are arranged radially in ellipse-like rings around the power conductors 410. The subsea electrical cable 400 of FIG. 4 includes two ellipse-like rings of reinforcing wires 420. The reinforcing wires 420 of FIG. 3 are made from steel. Aptly the reinforcing wires 420 are made from any other suitable metallic material. Aptly the reinforcing wires 420 are made from an alloy material. Aptly the reinforcing wires 420 are instead made from a non-metallic material, for example a composite material. As illustrated in FIG. 4, the reinforcing wires 420 are twisted with respect to a major axis 430 of the subsea electrical cable 400 that extends through the length 440 of the subsea electrical cable 400. That is to say, the inner ring 440 of reinforcing wires 420 is helically wound around the power conductors 410. The outer ring 450 of reinforcing wires 420 is wound around the inner ring 440 of reinforcing wires 420 and is wound helically with respect to the major axis 430 of the subsea electrical cable 400.

The subsea power cable also includes an outer sleeve 460. It will be appreciated that the outer sleeve 460 is substantially impermeable to water. The outer sleeve 460 thus acts to prevent leakage of water into the subsea electrical cable 400 which may act to damage the internal components of the cable 400. For example, when arranged in an offshore environment, seawater could cause the reinforcing wires 420 and/or the power conductors 410 to corrode. The outer sleeve 460 of FIG. 4 is made from a polymer material. Aptly the outer sleeve 460 could be made from a thermoplastic material. The outer sleeve 460 radially surrounds the reinforcing wires 420 and power conductors 410. That is to say, the reinforcing wires 420 and power conductors 410 are disposed within the outer sleeve 460.

FIG. 5 illustrates an alternative subsea electrical cable 500 in cross section. The subsea electrical cable 500 of FIG. 5 includes two power conductors 510. The subsea electrical cable of FIG. 5 also includes 28 reinforcing wires 520. The reinforcing wires 520 are arranged in two ellipse-like rings radially surrounding the power conductors 510. An outer sleeve 530 radially surrounds the outer ring 540 of reinforcing wires 520. As illustrated in FIG. 5, the cross section of the subsea electrical cable 500 is substantially elliptical. That is to say, a horizontal axis 550 of the cross section of the subsea electrical cable 500 is longer than a vertical axis 560 of the subsea electrical cable 500 (as shown in FIG. 5). The subsea power cable 500 thus has a substantially non-circular cross section. The cross section of the subsea electrical cable 500 includes two relatively long, curved edges 565, 570 (each having a relatively large radius of curvature) each adjoined by two relatively short, curved edges 575, 580 (each having a relatively small radius of curvature). It will be appreciated that, in use, the ellipse-like cross section of the subsea electrical cable 500 increases the contact area between the subsea electrical cable 500 and outer surface of a fluid pipe when the subsea electrical cable 500 is wound around said fluid pipe. It will be understood that this is because a longer edge 570 of the ellipse-like cross section of the subsea electrical cable 500 contacts an outer surface of a fluid pipe. Thus, the ellipse-like cross section of the subsea electrical cable 500 aids in the winding of the subsea electrical cable 500 around an outer surface of a fluid pipe. An increased contact area between the outer sleeve 530 of the subsea electrical cable 500 and an outer surface of a fluid pipe also acts to help self-support the subsea electrical cable 500 on said fluid pipe by increasing the frictional forces between the subsea electrical cable 500 a fluid pipe. It will be appreciated that friction can be measured in Newtons.

The ellipse-like cross section of the subsea electrical cable 500 also allows a hybrid pipe assembly including the subsea electrical cable 500 of FIG. 5, in which the subsea electrical cable is wound around an outer surface of a fluid pipe, to sit flush on the seabed in use. The ellipse-like cross section of the subsea electrical cable 500 wound around an outer surface of a fluid pipe provides a somewhat flattened surface, that is one of the long, curved edges of the cable 500 cross section 565, for the hybrid pipe assembly the contact the seabed. That is to say, the substantially flattened surface is provided by a radially outer edge of the ellipse-like cross section of the subsea electrical cable 500 that includes a long curved edge of the cable 500 cross section 565, when the subsea electrical cable 500 wound around the fluid pipe.

Aptly the cross section of the subsea electrical cable 500 may be any other suitable shape. Optionally the cross section of the subsea electrical cable 500 is substantially circular. Optionally the cross section of the subsea electrical cable 500 is stadium-like. That is to say, the cross section of the subsea electrical cable 500 may have two substantially flat edges arranged parallel with respect to each other, the flat edges each being adjoined by curved edges.

FIG. 6 illustrates a hybrid pipe system 600 in cross section. The hybrid pipe system of FIG. 6 may be substantially similar to the hybrid pipe system of FIG. 2. FIG. 6 illustrates how a bore 610 of a fluid pipe 620 of a hybrid pipe system 600 is surrounded by an inner liner 630. The inner liner 630 has a substantially circular cross section. Thus, the cross section of the bore 610 is substantially circular. The fluid pipe 620 of FIG. 6 has four further layers 635, 640, 645, 650 of composite material. Each of these layers 635, 640, 645, 650 has a circular cross section. The layers 635, 640, 645, 650 are arranged radially concentrically with respect to each other. That is to say, each of the layers 635, 640, 645, 650 has a different cross sectional radius, the layers of smaller cross sectional radius being arranged within the layers of larger cross sectional radius. Aptly, the composite layers 635, 640, 645, 650 include a thermoplastic composite. Aptly the composite layers 635, 640, 645, 650 are reinforced with non-metallic fibres.

FIG. 6 also illustrates how the hybrid pipe system 600 also includes a subsea electrical cable 660 that is tightly wound around an outer surface 665 outer surface of the fluid pipe 620. The cable 660 is tightly wound such that that a radius 670, that is a circle radius, of an imaginary circle 675 provided by a radially innermost surface of the windings of an outer sleeve 680 of the subsea electrical cable 660 is substantially the same as a radius 685, that is a circle radius, of an imaginary circle 690 that is provided by the outer surface 695 of the fluid pipe 620 cross section. The subsea electrical cable 660 is thus self-supported on the fluid pipe 620 due to the windings of the cable 660 around fluid pipe 620.

FIG. 7 illustrates a hybrid pipe system 700 arranged in a storage configuration 710. It will be appreciated that the hybrid pipe system is a pipe cable assembly. As illustrated in FIG. 7, in the storage configuration 710, the hybrid pipe system 700 is wound around a spool 720. That is to say that the fluid pipe 730 and the subsea electrical cable 740, which is wound around an outer surface 750 of the fluid pipe 730, are together wound around the spool 720. It will be appreciated that the spool 720 is an example of a storage spool element.

It will be appreciated that the fluid pipe 730 of FIG. 7 is a flexible fluid pipe and thus can be wound around the spool 720. However, it will be understood that alternative hybrid pipe systems 700, which are not configured to be arranged in a storage configuration 710, wherein the hybrid pipe system 700 is wound around a spool 720, may not include a flexible fluid pipe. The fluid pipe in such alternative hybrid pipe systems may instead be rigid for example.

It will be understood that the hybrid pipe system 700 of FIG. 7 can be wound around the storage spool 720 into the storage configuration 710 at the point of manufacture for storage. Alternatively, the hybrid pipe system 700 could be wound around the spool 720 into the storage configuration 710 after manufacture, and even following use of the hybrid pipe system 700. For example, the hybrid pipe system 700 may be removed from a first region of use, which may be an offshore energy hub for example, and may be transported to a further region of use, which may be a different offshore energy hub for example. Alternatively, the hybrid pipe system 700 may be stored in the storage configuration 710 following manufacture or following an initial (or subsequent) use of the hybrid pipe system 700.

It will be appreciated that the hybrid pipe system 700, arranged in the storage configuration 710, can be conveniently transported to a desired region. The desired region may be a region in which the hybrid pipe system 700 is to be used and/or installed in an energy hub. This may be, for, example, an offshore energy hub. The hybrid pipe system 700 may thus be intended to be connected to at least one element of such an offshore energy hub. The hybrid pipe system 700 may be intended to be connected between two, or more, elements of an offshore energy hub. It will be understood that, once at the desired region, the hybrid pipe system 700 can be unrolled for installation. That is to say that the fluid pipe 730 and the subsea electrical cable 740, that is wound around an outer surface 750 of the fluid pipe 730, of the hybrid pipe system 700 can be unrolled together as a common unit. That is to say the hybrid pipe system 700 can be unrolled as a single entity. Thus, during installation of the hybrid pipe system 700, the subsea electrical cable 740 need not be independently connected to the fluid pipe 730 following installation of the fluid pipe 730 at a desired region. In particular, the subsea electrical cable 740 need not be connected to a fluid pipe 730 which is disposed in an offshore environment and may be submerged in water.

It will be appreciated that the inter-twining of the two elements of the hybrid-pipe system may be performed offshore during the delivery and installation processes. As such the fluid pipe 730 and the subsea electrical cable 740 may be provided separately on reels, then as the pipe is spooled from a storage spool 720 during installation a separate reel of cable may be cycled around the fluid pipe to substantially helically wind the subsea electrical cable 740 around the fluid pipe 730.

FIG. 8 illustrates deployment and installation of a hybrid pipe system 800 at an offshore wind farm 810 that is an offshore region. The offshore wind farm 810, that is an offshore region, is an example of an offshore energy hub that is an example of a desired region. It will be appreciated that the hybrid pipe system could be deployed and installed at any other suitable desired region.

The offshore wind farm 810 includes an offshore wind turbine 815. The offshore wind turbine 815 includes a monopile 820 that extends into the seabed 822. The monopile is partially submerged in seawater 824. The offshore wind turbine 815 also includes three turbine blades 824 and a rotor 826 that is connected to a turbine head 827. The turbine head 827 is mounted on a tower 828 of the wind turbine 815.

The offshore wind farm 810 also includes an electrolysis structure 830 for producing “green” (environmentally friendly) hydrogen using electricity generated by the offshore wind turbine 815. The electrolysis structure 830 is an example of a fluid production element. Also included in the offshore wind farm 810 is a gas storage structure 835. It will be appreciated that the gas storage structure 835 is an example of a fluid storage element. The gas storage structure is configured to store hydrogen produced at the electrolysis structure 830.

It will be appreciated that both the electrolysis structure 830 and the gas storage structure 835 require power to function. For example, operating pumps for gas transport, operating valves for gas storage, and producing hydrogen from water via electrolysis, and the like and all examples of operations that require power. Similarly, hydrogen produced at the electrolysis structure 830 must be transported to the gas storage structure 835 for storage. FIG. 8 thus illustrates installation of a hybrid pipe system 800 between the electrolysis structure 830 and gas storage structure 835 for the simultaneous transport of fluid, that in FIG. 8 is hydrogen, and transmission of power between the electrolysis structure 830 and gas storage structure 835.

The hybrid pipe system 800 includes a fluid pipe 840 and a subsea power cable 845 wound around an outer surface 850 of the fluid pipe 840. It will be appreciated that the fluid pipe 840 facilitates the transport of hydrogen between the electrolysis structure 830 and the gas storage structure 835. It will be appreciated that the subsea power cable facilitates power transmission between the electrolysis structure 830 and the gas storage structure 835. Optionally, power generated by the offshore wind turbine 815 is initially transmitted to the electrolysis structure (by suitable cables or the like) 830 and subsequently is transmitted to the gas storage structure 835 via the subsea power cable 845.

A storage spool 852 is arranged on a vessel 854, that is a ship. The vessel 854 is an example of a deployment element. It will be appreciated that the hybrid pipe system 800 is initially loaded onto the vessel 854 in a storage configuration in which the hybrid pipe system is wound around the spool 852. The storage configuration of the hybrid pipe system 800 of FIG. 8 is similar to that shown in FIG. 7.

FIG. 8 illustrates the hybrid pipe system 800 partially unrolled from the storage spool 852. A first terminal end 856 of the hybrid pipe system 800 is connected to the electrolysis stricture 830. It will be appreciated that a first terminal end of the subsea power cable 845 will be connected to a suitable electrical connector of the electrolysis structure 830. It will be appreciated that a first terminal end of the fluid pipe 840 will be connected to a suitable pipe termination connector of the electrolysis structure 830.

The hybrid pipe system 800 is unrolled from the spool 852 as a single unit as it is deployed at the offshore wind farm 810. That is to say that the fluid pipe 840 and the subsea electrical cable 845, which is wound around the outer surface 850 of the fluid pipe 840, are unrollable from the spool together as a common unit. This the subsea electrical cable 845 and the fluid pipe 840 need not be independently deployed. The hybrid pipe system 800 is deployed such that it is laid across the seabed 822. That is to say that the hybrid pipe system 800 is deployed such that the hybrid pipe system 800 is submerged and extends long a region of seabed 822 between the electrolysis structure 830 and gas storage structure 835. Optionally the hybrid pipe structure 800 is deployed such that it extends beneath the seabed 822.

It will be appreciated that once the hybrid pipe system 800 is unrolled from the spool 852, a remaining terminal end of the hybrid pipe system is connected to the gas storage structure 835. It will be appreciated that the remaining terminal end of the subsea power cable 845 will be connected to a suitable electrical connector of the gas storage structure 835. It will be appreciated that a remaining terminal end of the fluid pipe 840 will be connected to a suitable pipe termination connector of the gas storage structure 835.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An apparatus for simultaneously transmitting power and transporting at least one fluid, comprising:
a pipe member comprising a fluid retaining liner that defines a bore of the pipe member; and
at least one elongate flexible element comprising an outer sleeve and at least one electrically conducting element disposed within the outer sleeve,
wherein the elongate flexible element is wound around the outer surface along at least a portion of the pipe member.

2. The apparatus as claimed in claim 1, wherein a first imaginary circle associated with a radially innermost surface of the outer sleeve of the wound elongate flexible element has a circle radius substantially equal to a circle radius of a further imaginary circle associated with the outer surface.

3. The apparatus as claimed in claim 1, wherein a pitch between adjacent corresponding points of the wound elongate flexible element is in the range between two times a diameter of the outer surface in cross section and 50 times the diameter of the outer surface in cross section.

4. The apparatus as claimed in claim 1, wherein the elongate flexible element wound around the outer surface is self-supported on at least a portion of the pipe member, the elongate flexible element optionally being helically wound around the outer surface.

5. The apparatus as claimed in claim 1, wherein the elongate flexible element has a non-circular cross section that is optionally substantially elliptical.

6. The apparatus as claimed in claim 1, wherein the pipe member comprises a composite material, the composite material optionally comprising a thermoplastic matrix and fibres of a non-metallic material.

7. The apparatus as claimed in claim 1, wherein a weight of the elongate flexible element is equal to or greater than a buoyancy of the pipe member when the pipe member is filled with gas.

8. The apparatus as claimed in claim 1, wherein, in a storage configuration, the pipe member and the elongate flexible element wound around the outer surface are wound together around a spool and are unrollable as a common unit.

9. An offshore energy hub, comprising:
the apparatus as claimed in claim 1 disposed between at least two of:
an energy generation element;
an energy storage element;
a fluid production element;
a fluid storage element; and
an offloading element.

10. The offshore energy hub as claimed in claim 9, wherein the energy generation element comprises a wind turbine or a subsea turbine.

11. The offshore energy hub as claimed in claim 9, wherein the fluid production element comprises at least one electrolysis system for generating hydrogen and/or at least one compression system to liquefy hydrogen.

12. The offshore energy hub as claimed in claim 9, wherein the fluid storage element comprises a geological reservoir.

13. The offshore energy hub as claimed in claim 9, wherein the energy storage element comprises batteries.

14. A method of installing a pipe member and an elongate flexible element at a desired location, comprising unwinding the apparatus as claimed in claim 10 from the spool at a desired location that optionally is an offshore location.

15. A method of simultaneously transmitting power and transporting at least one fluid, comprising:
providing at least one fluid at first location of a bore defined by a fluid retaining inner liner of a pipe member;
providing power via least one electrically conducting element disposed within an outer sleeve of an elongate flexible element, the elongate flexible element being wound around an outer surface of the pipe member along at least a portion of the pipe member;
transporting the fluid in a first direction along the bore of the pipe member from the first location to a second location that is spaced apart from the first location along the bore of the pipe member; and
providing power through the electrically conducting element at least partly during, or at all times during, transport of the fluid.

16. The method as claimed in claim 15, further comprising providing power in a transmission direction that is opposite to or aligned with a direction in which fluid is transported.

17. The method as claimed in claim 15, whereby the fluid comprises hydrogen.

18. The method as claimed in claim 15, further comprising, via the bore, transporting the fluid from a first structure to a further structure and simultaneously transmitting, via the electrically conducting element, power from the first structure to a further structure or from the further structure to the first structure, the first and further structure each optionally being a respective offshore structure.

19. A method of manufacturing a pipe-power cable assembly, comprising:
providing a pipe member comprising a fluid retaining inner liner that defines a bore of the pipe member;
providing an elongate flexible element comprising an outer sleeve and at least one electrical conductor element arranged within the outer sleeve; and
winding the elongate flexible element around the outer surface along at least a portion of the pipe member.

20. The method as claimed in claim 19, further comprising, subsequent to winding the elongate flexible element around the outer surface, simultaneously winding the pipe member, and the elongate flexible element wound around the outer surface of the pipe member, together around a storage spool element.
